(19) United States
(12) Patent Application Publication
(10) Pub. No.: US 2003/0178802 A1
(43) Pub. Date: Sep. 25, 2003

(54) Rear wheel assembly for a field finishing land plane

(76) Inventors: Ralph H. Atkins, Paradise, CA (US); Evelyn R. Atkins, Paradise, CA (US)

Correspondence Address: Ralph H. Atkins, P.O. Box 1047, Paradise, CA, 95967, US

(21) Appl. No.: 10/101,898

(22) Filed: Mar. 21, 2002

(51) Int. Cl. B62D 1/00

(52) U.S. Cl. 280/81.1

(57) ABSTRACT

A rear wheel assembly replaces single large rollers normally used on the rear of forty-foot field finishing land planes. The assembly provides units having one pneumatic tired wheel mounted to swivel under a narrowed platform at the front and two pneumatic tired wheels on an axle at the rear. The wheel assembly attaches by swivel stud to original swivel stud receivers at the back frame of the land plane.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

This invention relates to a pneumatic tired rear wheel assembly for a field finishing land plane. The assembly of the present invention has three wheels in a tricycle arrangement. The three wheels have pneumatic tires. A straight sided housing with an angled in front houses the wheels. There are two wheels outside at the rear of the housing and a single wheel under the housing at the front. The two rear wheels are on a stationary axle. The single front wheel swivels. Two of the devices of the present invention replace two all metal swivel rollers on the rear of a field finishing land plane. Most field finishing land planes ride on two large swiveling rollers at the rear and two large rollers yoked side by side on the front when leveling a field. The front rollers are arranged to turn with a tow bar for steering. A tractor usually tows the forty-foot long land plane during fieldwork. When moving the equipment from place to place, a truck normally replaces the tractor for towing along a road or freeway. During truck towing, two retractable pneumatic tired wheels are lowered at the center area of the land plane. This raises the rear swiveling rollers off the ground, and the land plane rides on the two pneumatic tired wheels and on the front rollers. The rollers make stabilization and alignment of the land plane difficult during fieldwork. The rollers also make road steering hard even with protruding ends of the land plane scoop raised or swung around to narrow road width required. Our experiments have shown that replacing rollers on a field finishing land plane with wheels having pneumatic tires greatly improves handling characteristics of this equipment. Replacing the two large front rollers with double pneumatic tired wheels, two wheels for each roller in the tow bar steering yoke, improves road steering considerably. Replacing the rear swiveling rollers proved more difficult. Several wheel combinations were tried using wheels with pneumatic tires. When the single rollers on the rear of the land plane were replaced with single pneumatic tired wheels, narrow tires did not support the rear as needed and wide tires did not swivel well enough. Doubling the tired wheels failed to improve anything. Two wheels in tandem were not easy to control. A four-wheeled unit worked well but proved too bulky. The best replacements for the two swiveling rear rollers turned out to be three pneumatic tired wheels in a tricycle arrangement having a single front wheel that swiveled.

The present invention provides this arrangement in a three-wheel assembly that replaces single large rollers normally used on the rear of forty-foot land planes. The new rear wheel assembly has three pneumatic tired wheels mounted in a straight-sided body. The body has a triangular front section and a rounded front end. The body of the assembly is structured of a metal frame supporting sheet-metal housing. The assembly body attaches to the rear frame of the land plane by a swivel stud in a center yoke. The swivel stud fits the same cylindrical receivers to which the original rollers attach. A single wheel on the front of the assembly also swivels. With two of my wheel assemblies replacing the two rear rollers, strain on the pulling vehicle is reduced and the field finishing land plane is easier to align. Steering the land plane during road towing is greatly improved when the front rollers are replaced with pneumatic tired wheels.

### BRIEF SUMMARY OF THE INVENTION

My invention is a three-wheel assembly housed in a triangular frame. The frame has a sheet-metal covered housing. Two wheels are at the wide back of the housing. A single wheel is arranged pivotal in the narrowed front of the housing. The three wheels on the assembly are fitted with pneumatic tires. An inverted U-shaped yoke straddles the housing. A swivel stud centered in the top of the yoke is sized to fit pivotal acceptors on the rear of the land plane where the rollers fasten on. Thus the rear wheel assembly of my invention can replace the rollers on the rear of the land place using the same swivel stud receivers that held the original rollers. To further enhance control of the land plane, the alignment of rollers arranged on the front of the land plane to turn with the tow bar can be replaced with an alignment of pneumatic tired wheels.

### BRIEF DESCRIPTION OF THE SEVERAL VIEWS OF THE DRAWINGS

FIG. 1 shows the present invention in a side elevation view from a first side.

FIG. 2 shows the invention in a top plan view.

FIG. 3 shows the invention in a perspective view.

FIG. 4 shows two units of the present invention in a perspective view from a second side being attached to the rear of a field finishing land plane to replace the rollers normally there. The alignment of rollers usually arranged to turn with the tow bar of the land plane at the front have been replaced with an alignment of pneumatic tired wheels.

FIG. 5 shows the field finishing land plane being towed. The present invention is attached pivotally at the rear of the land plane in the position where the rollers would normally be. An alignment of pneumatic tired wheels is shown replacing the rollers at the tow bar. For road towing the ends of the scoop have been raised, retractable wheels near the scoop have been lowered raising the two units of the present invention at the rear of the land plane free of the ground.

### DETAILED DESCRIPTION OF THE INVENTION

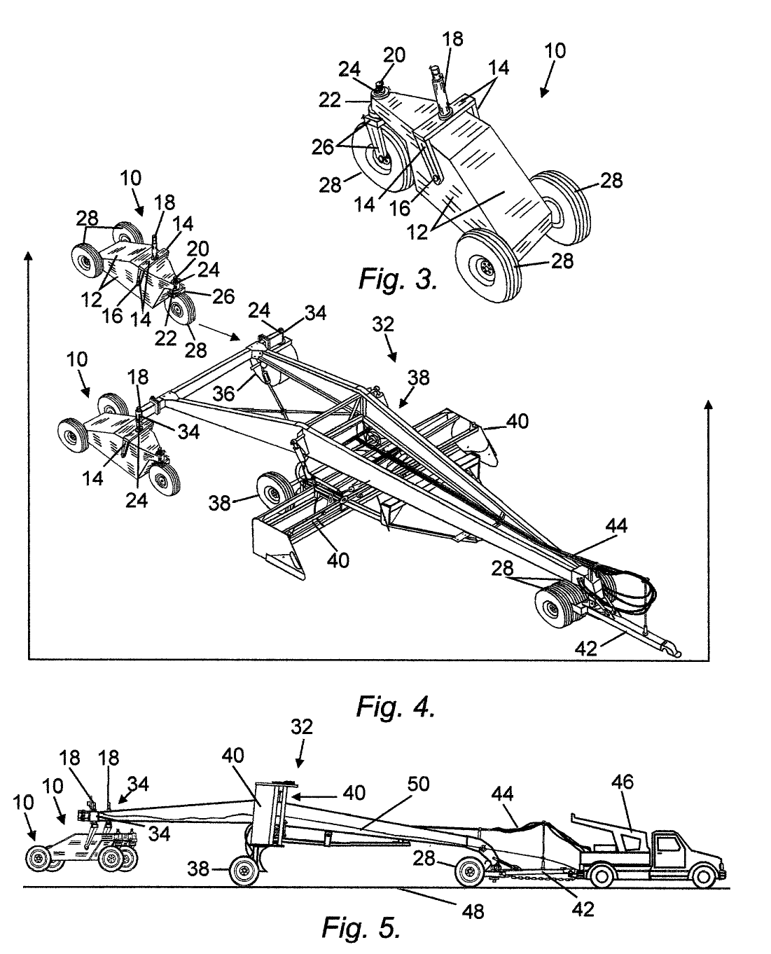

Referring now to the drawings where my invention is referenced generally as invention 10 and alternatively as rear wheel assembly 10. The numbered parts in the drawings include numbers to designate critical parts of existing field finishing land plane 32. The device of the present invention, rear wheel assembly 10, is designed to replace original rollers 36 on field finishing land plane 32 as can be seen in FIG. 4 of the drawings.

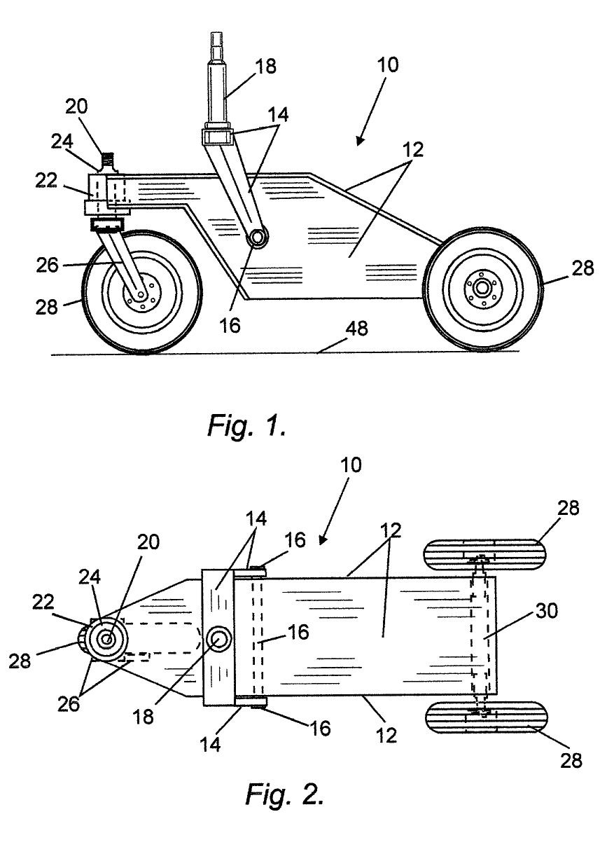

At FIG. 1 in the drawings, rear wheel assembly 10 is shown in a side elevation view from a first side. Two perspective views of rear wheel assembly 10 in FIG. 4 show a second side. Although rear wheel assembly 10 could be manufactured from a variety of materials now known and from products of future development, rear wheel assembly 10 in this embodiment has a metal frame (not visible) supporting a sheet-metal housing designated wheel assembly body 12. For attachment to the rear frame of a field finishing land plane 32, an inverted U-shaped wheel assembly swing yoke 14 is arranged to support wheel assembly body 12 as a pivotal hanger. A first arm of inverted U-shaped swing yoke 14 fastens to wheel assembly body 12 by swing yoke attachment axle 16. Axle 16 passes completely through wheel assembly body 12 and attaches to a second arm of swing yoke 14 on the other side. Swing yoke attachment axle 16 is positioned at the ascertained center of gravity allowing wheel assembly body 12 to swing freely in a position nearly paralleling ground line 48. Centered in the top of swing yoke 14, is swivel stud 18. Swivel stud 18 fits the existing swivel stud receiver 34 on field finishing land plane 32 as shown in FIG. 4. Swivel stud receiver 34 is the same tubular holder that fits the swivel stud on original rollers 36.

As can be seen in the FIG. 1 drawing, the sides of assembly body 12 angle upwards at the front then straighten out into a small rounded platform supporting front wheel swivel stud receiver 22. Front wheel swivel stud 20 on the top cross member of front wheel inverted L-shaped single arm yoke 26 is retained pivotal in front wheel swivel receiver 22 by retaining collar 24. Front wheel inverted L-shaped single arm yoke 26 has the longer arm attached to only one side at the hub of pneumatic tired front wheel 28. The angled front-end platform of assembly body 12 provides opened wheel housing allowing single pneumatic tired wheel 28 installed there to swivel completely around free of any restrictions. Two other pneumatic tired wheels 28 are affixed by axle 30 (see FIG. 4.) at the widened rear end of wheel assembly body 12. For towing alignment, single front wheel 28 swivels when all wheels 28 on wheel assembly body 12 are in contact with ground surface 48.

The top plan view of invention 10 in FIG. 4 shows wheel assembly body 12 to have straight sides that angle inward at a front section to end in a rounded nose supporting front wheel swivel stud receiver 22. The single pneumatic tired front wheel 28 that swivels can be partly seen and its position is indicated by dotted lines. Front wheel inverted L-shaped single arm yoke 26 is partly shown and illustrated by dotted line below front wheel swivel stud 20, front wheel stud receiver 22, and swivel stud retainer collar 24. The top of assembly body swing yoke 14 is shown crossing over the upper section of assembly body 12 towards the front where assembly body 12 angles inward to form a rounded nose. Assembly body swivel stud 18 is in the center of assembly body swing yoke 14. The two side arms of yoke 14 and where they fasten to assembly yoke axle 16 are shown. Dotted lines indicate the position of yoke axle 16 passing through assembly body 12. Two pneumatic tired wheels 28 can be seen affixed to axle 30 at the rear of assembly body 12. Axle 30 is indicated by dotted lines.

As parts numbers describing assembly body 12 previously for FIG. 1 and FIG. 2 appear in FIGS. 3, 4, and 5, descriptions of these parts are not duplicated. FIG. 3 is a perspective view of the present invention 10 primarily illustrating rear wheel assembly body 12 and visible parts from the same side as was seen in FIG. 1. Rear wheel assembly 10 is shown in two perspective illustrations from the opposite side in FIG. 4. Also, a drawing of an original field finishing land plane 32 is shown in a perspective view in FIG. 4. An elevation side view of land plane 32 equipped with two of the rear wheel assemblies 10 of this invention being towed by truck 46 is shown in FIG. 5. In the perspective view at FIG. 4 of land plane 32, the original upper rear roller 36 is about to be replaced by the present invention, rear wheel assembly 10. The original land plane swivel stud receiver 34 will be used to attach rear wheel assembly 10 by inserting assembly swivel stud 18 into land plane original stud receiver 34 and locking it there with swivel stud retainer collar 24. Other important parts of land plane 32 include retractable pneumatic tired wheels 38. Wheels 38 can be raised for fieldwork when a tractor normally tows land plane 32. During field leveling, the center section of the scoop and the extended ends 40 are aligned. Land plane 32 rides on the three wheels 28 each of the two rear assemblies 10 and the four-ganged tow bar steering wheels 28 at the front. The center scoop is on the ground. For fieldwork, a tractor would normally tow land plane 32. During movement from field to field along a road or highway, land plane 32 would be attached by tow bar 42 to truck 46. Hydraulic lines 44 from truck 46 would operate raising and lowering of wheels 38. Wheels 38 would be down and land plane 32 would be riding on retractable center wheels 38 and front-ganged wheels 28. Both attached units of the present invention, rear wheel assemblies 10, would be raised free of ground 48. Taillights and stoplights on the rear frame of land plane 32 would be operated from truck 46 by taillights and rear signal power and control line 50.

A reading of described and numbered parts in this specification and considering them relative to like numbered parts shown in the appended drawings should provide a clear picture of the present invention.

The detailed description of a particular embodiment of this invention in the foregoing specification is not intended to limit changes I may make which fall within the scope of my claims, however, this does not included changes by others who claim new invention in similar devices when their claim or claims fall within my claim scope.

What is claimed is:

1. A rear wheel assembly for a field finishing land plane, comprising:
a. a wheel assembly body said wheel assembly body having a front end and a rear end designation;
b. material means for manufacturing of said wheel assembly body;
c. at least one pneumatic tired wheel;
d. means for attachment of said pneumatic tired wheel to said wheel assembly body;
e. means allowing said pneumatic tired wheel to swivel;
f. means providing structure for attachment of said wheel assembly body to a field finishing land plane with said wheel assembly body held substantially parallel lengthwise to a level surface when said wheel assembly body is not in contact with said level surface;
g. means allow free turning of said wheel assembly body on a vertical axis;
h. means for attachment of said wheel assembly body to the back frame of a field finishing land plane;
i. removable means for locking said attachment;
j. means providing said wheel assembly body stability for ground contact mobility;
k. at least one inverted L-shaped wheel mounting yoke, there being a swivel stud affixed on the short leg to a top surface thereof, and
l. at least one inverted U-shaped yoke sized to fit said wheel assembly body, there being a swivel stud affixed centrally to the crossed member of the U on a top surface thereof.

2. The rear wheel assembly for a field finishing land plane according to claim 1, wherein said wheel assembly body is substantially rectangular with an angled down rear end and an angled up front end, said front end ending in a rounded platform forming a wheel well under said platform.

3. The rear wheel assembly for a field finishing land plane according to claim 1, wherein said wheel assembly body can be manufactured of a variety of known materials and materials later developed with the material of choice now being a sheet-metal covering over a metal frame.

4. The rear wheel assembly for a field finishing land plane according to claim 1, wherein said means for attachment of said at least one pneumatic tired wheel to said wheel assembly body includes afixment thereto by said at least one inverted L-shaped wheel mounting yoke.

5. The rear wheel assembly for a field finishing land plane according to claim 1, wherein said means allowing said at least one pneumatic tired wheel to swivel includes said swivel stud on top of said L-shaped single wheel yoke holding said at least one pneumatic tired wheel attached to a swivel stud receiver in said front end of said rear wheel assembly in a manner allowing said pneumatic tired to swivel freely.

6. The rear wheel assembly for a field finishing land plane according to claim 1, wherein said means supporting said wheel housing body substantially parallel with a level surface when said wheel assembly body is not in contact with said level surface includes said at least one inverted U-shaped yoke sized to fit said wheel assembly body said swing yoke supports said wheel assembly body when attached to a field finishing land plane frame as a swing hanger.

7. The rear wheel assembly for a field finishing land plane according to claim 1, wherein said means allowing free turning of said wheel-housing body on a vertical axis includes said swivel stud on the top surface of said at least one inverted U-shaped assembly swing yoke holding said wheel housing body attached to said field finishing land plane in an original swivel receiver allowing said wheel housing body to turn freely on a vertical axis.

8. The rear wheel assembly for a field finishing land plane according to claim 1, wherein said means for attachment of said wheel housing body to the back frame of a field finishing land plane includes a swivel stud on the top of an assembly swing yoke affixed to said wheel housing body, said swivel stud sized for and fitting original stud receivers on a field finishing land plane.

9. The rear wheel assembly for a field finishing land plane according to claim 1, wherein said means for locking said attachment includes a universal locking collar sized for locking swivel studs into land plane stud receivers and into stud receivers on auxiliary equipment.

10. The rear wheel assembly for a field finishing land plane according to claim 1, wherein said means allowing said wheel housing body stability for ground contact mobility includes additional pneumatic tired wheels installed on said wheel housing body.
